(19) United States
(12) Patent Application Publication
(10) Pub. No.: US 2008/0309654 A1
(43) Pub. Date: Dec. 18, 2008

(54) COMMON VOLTAGE SOURCE OF LIQUID CRYSTAL DISPLAY AND CHARGE RECYCLING SYSTEM APPLYING THE COMMON VOLTAGE SOURCE

(76) Inventors: Chen-Hsien Han, Hsinchu City (TW); Wei-Shan Chiang, Tai-Chung City (TW); Ming-Huang Liu, Taipei Hsien (TW); Wei-Yang Ou, Kao-Hsiung City (TW); Chi-Mo Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/963,862

(22) Filed: Dec. 24, 2007

(30) Foreign Application Priority Data
Jun. 14, 2007 (TW) 096121528

(51) Int. Cl. G09G 5/00; G09G 3/36

(52) U.S. Cl. 345/211; 345/87

(57) ABSTRACT

A charge recycle system implemented in a liquid crystal display includes a common voltage source, a control unit, and a source driving circuit. Before the common voltage source switches its common voltage level, the control unit controls the common voltage source to let a voltage driving circuit of the common voltage source not coupled to the output end of the common voltage source, and sends a charge recycle enable signal to the source driving circuit to adjust the source voltage level. By boosting or pulling down the source voltage level, the charges stored in liquid crystal units of the liquid crystal display can be recycled to the common voltage source, therefore raising charge utilization efficiency and lowering power consumed by the liquid crystal display.

### BACKGROUND OF THE INVENTION

1. Field of the Invention

The present invention relates to a power supplying mechanism, and more particularly, to a charge recycling system applying a common voltage source of a liquid crystal display (LCD).

2. Description of the Prior Art

Generally, a conventional LCD comprises a plurality of LCD cells arranged in a matrix. FIG. 1 shows a connection relationship between an LCD cell 10, a gate driving circuit 12, a common voltage source 14 and a source driving circuit 16 of the conventional LCD. When the common voltage source 14 switches the common voltage level V_{COM} or when the source driving circuit 16 switches the source voltage level V_{SOURCE}, a storage capacitor C_{S}, a parasitic capacitor C_{P} and a parallel-plate capacitor C_{LCD} in the LCD cell 10 are charged or discharged, respectively. Then, when conducted by a gate driving signal outputted from the gate driving circuit 12, the LCD cell 10 displays luminance according to the voltage level of the storage capacitor C_{S}, the parasitic capacitor C_{P} and the parallel-plate capacitor C_{LCD}; therefore, pictures having different colors can be shown on the LCD after the LCD cells are filtered by RGB filters.

FIG. 2 is a diagram of a conventional common voltage source structure. As shown in FIG. 2, the common voltage source 14 comprises a high common voltage source 142 for providing a high common voltage level V_{COMH}, and a low common voltage source 144 for providing a low common voltage level V_{COML}. A high common voltage driving circuit 146 of the high common voltage source 142 stores positive charges in a capacitor 148 and keeps the cross voltage of the capacitor 148 at the high common voltage level V_{COMH}. Likewise, a low common voltage driving circuit 152 of the low common voltage source 144 stores negative charges in a capacitor 154 and keeps the cross voltage of the capacitor 154 at the low common voltage level V_{COML}. When switching the common voltage level V_{COM}, the common voltage source 14 controls the close and open states of switches 150 and 156. In this way, charges stored in the capacitor 148 or the capacitor 154 will transfer into the capacitors C_{S}, C_{P}, C_{LCD} of the VCD cell 10, and charge or discharge (respectively) the capacitors C_{S}, C_{P}, C_{LCD} to the switched common voltage level. Meanwhile, the high common voltage driving circuit 146 or the low common voltage driving circuit 152 continues to provide charges to the capacitor 148 or 154 to maintain the cross voltage of the capacitor 148 or 154 at the high common voltage level V_{COMH} or the low common voltage level V_{COML}, respectively.

Charges stored in the capacitors C_{S}, C_{P}, C_{LCD} vanish through discharging routes naturally after the display of the LCD cell 10 is complete, however, and these insufficiently utilized charges give rise to a charge utilization efficiency and power consumption problem for LCDs.

### SUMMARY OF THE INVENTION

One objective of the present invention is therefore to provide a common voltage source and a charge recycling system applied to the common voltage source, to allow the common voltage source to reuse charges stored in the LCD. The charge utilization efficiency of the LCD is thereby raised and power consumption is significantly reduced.

According to an exemplary embodiment of the present invention, a common voltage source applied in an LCD is disclosed. The common voltage source comprises a charge-storing unit, a voltage driving circuit, a first controlling circuit and a second controlling circuit. The voltage driving circuit is for providing a common voltage level. The first controlling circuit selectively couples an output end of the voltage driving circuit to the charge-storing unit according to a first controlling signal, and the second controlling circuit selectively couples the charge-storing unit to an output end of the common voltage source according to a second controlling signal.

According to another exemplary embodiment of the present invention, a charge recycling system is disclosed. The charge recycling system comprises a common voltage source, a controlling unit and a source driving circuit, wherein the common voltage source comprises a first voltage source for outputting a first common voltage level. The first voltage source comprises a charge-storing unit for regulating and storing the first common voltage level, a voltage driving circuit for providing a voltage, a first controlling circuit and a second controlling circuit. The first controlling circuit selectively couples an output end of the voltage driving circuit to the charge-storing unit according to a first controlling signal, and the second controlling circuit selectively couples the charge-storing unit to an output end of the common voltage source according to a second controlling signal. The controlling unit is coupled to the common voltage source, and generates the first and second controlling signals and a charge recycling enabling signal, wherein the charge recycling enabling signal is outputted when the first controlling circuit is not coupled to the voltage driving circuit and the charge-storing unit, and the second controlling circuit is coupled to the charge-storing unit and the output end of the common voltage source. The source driving circuit is coupled to the controlling unit, and is for adjusting a source voltage level when receiving the charge recycling enabling signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a connection relationship between an LCD cell, a gate driving circuit, a common voltage source and a source driving circuit of a conventional LCD.

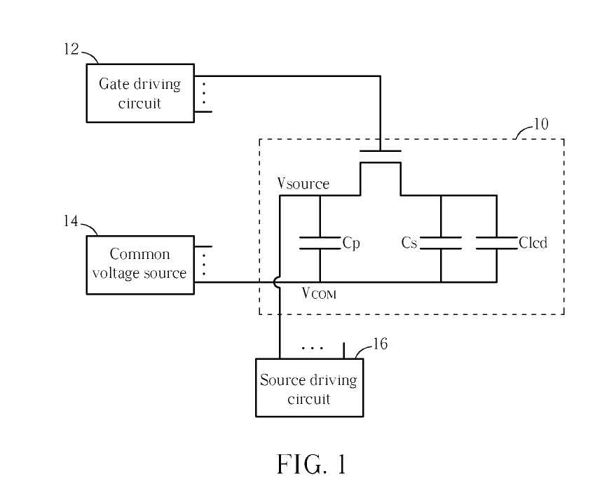

FIG. 2 is a diagram of a conventional common voltage source structure.

FIG. 3 is a diagram of a charge recycling system implemented in an LCD according to an exemplary embodiment of the present invention.

FIG. 4 is a diagram showing a relationship between a source voltage level V_{SOURCE}, a common voltage level V_{COM} and controlling signals utilized by the charge recycling system shown in FIG. 3.

### DETAILED DESCRIPTION

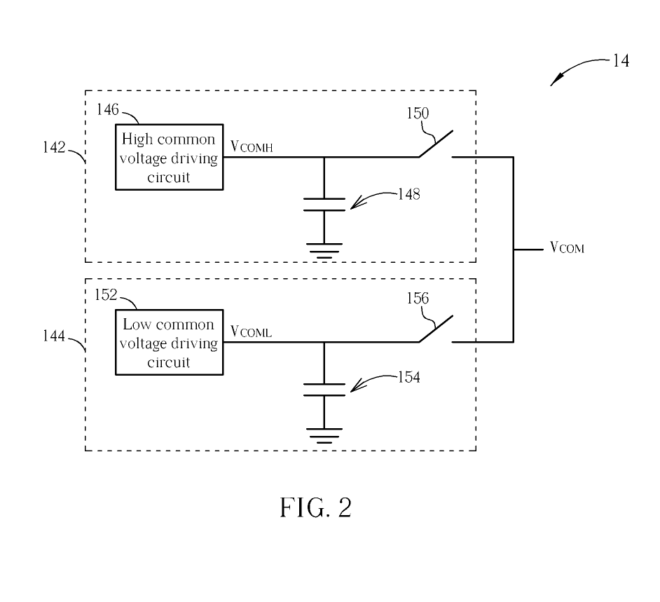

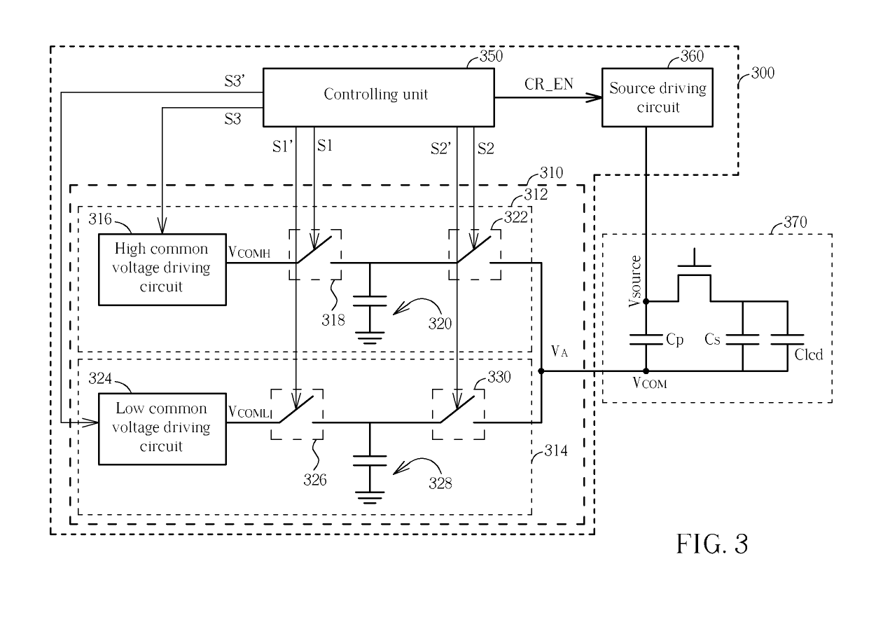

Please refer to FIG. 3, which is a diagram of a charge recycling system 300 implemented in an LCD according to an exemplary embodiment of the present invention. The charge recycling system 300 includes a common voltage source 310, a controlling unit 350 and a source driving circuit 360. The common voltage source 310 and the source driving circuit 360 are respectively coupled to each end of the parasitic capacitor C_{P} of an LCD cell 370, and are controlled by the controlling unit 350 to recycle charges from the parasitic capacitor C_{P}. Please note that, for clarity, FIG. 3 only shows a single LCD cell 370, though the common voltage source 310 and the source driving circuit 360 actually are coupled to a plurality of LCD cells. Compared to the conventional common voltage source 14 shown in FIG. 2, first controlling circuits 318 and 326 are further included in a high common voltage source 312 and a low common voltage source 314, respectively, in the common voltage source 310 in this embodiment. The first controlling circuits 318 and 326 are utilized to selectively couple the output ends of the high common voltage driving circuit 316 and the low common voltage driving circuit 324 to the capacitors 320 and 328, respectively. In this embodiment, the first controlling circuits 318 and 326 and second controlling circuits 322 and 330 for selectively coupling the capacitors 320 and 328 to the output end V_{A} of the common voltage source 310 are all implemented by switches. That said, any circuit or element able to achieve coupling and opening functions (such as a switching circuit composed of transistors) or able to form high impedance at output ends of the high common voltage driving circuit 316 and the low common voltage driving circuit 324 can be utilized to implement the first controlling circuits 318 and 326 and the second controlling circuits 322 and 330.

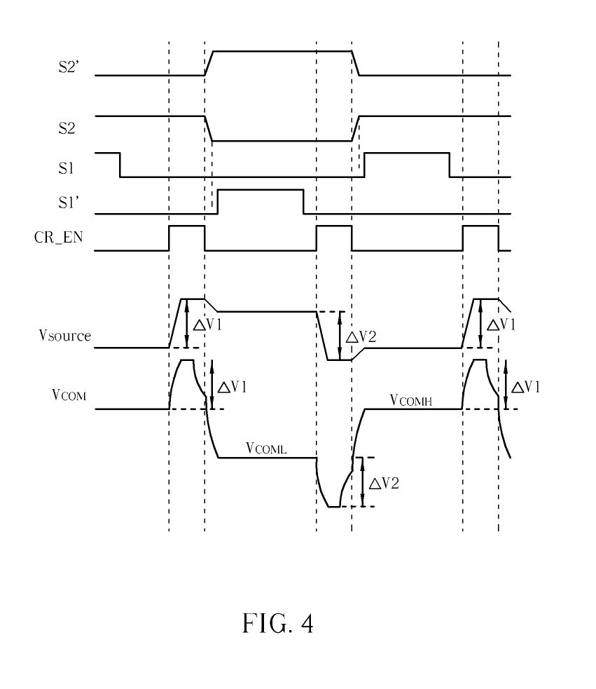

FIG. 4 shows a diagram of a relationship between controlling signals utilized by the charge recycling system 300 shown in FIG. 3 and source voltage level V_{SOURCE} and common voltage level V_{COM}. Referring to FIG. 3 in conjunction with FIG. 4, when the output voltage level of the common voltage source 310 is the high common voltage level V_{COMH} and the charge recycling system starts to act, the first controlling circuits 318 and 326 are both open while the second controlling circuit 322 is closed and the second controlling circuit 330 is open. Therefore, the output end of the high common voltage driving circuit 316 is not coupled to the capacitor 320, the output end of the low common voltage driving circuit 324 is not coupled to the capacitor 328, and the output end V_{A} of the common voltage source 312 is coupled to the capacitor 320. When the LCD cell 370 switches its polarity (i.e. the common voltage level V_{COM} is switching from the high common voltage level V_{COMH} to the low common voltage level V_{COML}), the controlling unit 350 outputs the charge recycling enabling signal CR_EN to the source driving circuit 360, boosting the source voltage level V_{SOURCE} for ΔV1. (Note that when the LCD cell 370 is about to switch its polarity, the driving signals of both the gate line and source line corresponding to the LCD cell 370 are disabled, and the LCD cell 370 is therefore not conducting, whereas the source driving voltage for the next conduction has not yet been inputted to the LCD cell 370.) Since the voltage across the capacitor C_{P} does not change immediately, the common voltage level V_{COM} raises ΔV1 correspondingly. Charges stored in the parasitic capacitor C_{P} therefore charge the capacitor 320 through the second controlling circuit 322 conducted by the second controlling signal S2, achieving the objective of recycling the charge. Because the capacitor 320 has already stored part of the charges recycled from the parasitic capacitor C_{P}, next time when the common voltage source 310 provides the high common voltage level V_{COMH}, the time required for the high common voltage driving circuit 316 to charge the capacitor 320 to the high common voltage level V_{COMH} is shortened and power consumption is further reduced. Because part of the charge is provided by the previous recycle charge from the parasitic capacitor C_{P}.

Next, when the charge recycling is complete and the LCD cell 370 switches its polarity, the controlling circuit 350 controls the first controlling signal S1 and the second controlling signal S2 to open the first controlling circuit 318 and the second controlling circuit 322, and then controls the second controlling signal S2′ to conduct the second controlling circuit 330 in order to reuse the charges recycled into the capacitor 328. After that, the controlling circuit 350 controls the first controlling signal S1′ to conduct the first controlling circuit 326. The low common voltage driving circuit 324 keeps providing charge to the capacitor 328 to maintain the voltage across capacitor 328 at the low common voltage level V_{COML} until the output voltage level of the common voltage source 310 reaches the low common voltage level V_{COML}.

When the LCD cell 370 is going to switch its polarity another time, (i.e. when the common voltage level V_{COM} is to be switched from the low common voltage level V_{COML} to the high common voltage level V_{COMH}), the controlling unit 350 outputs the charge recycling enabling signal CR_EN to the source driving circuit 360 to pull down the source voltage level V_{SOURCE} for ΔV2. Similarly, since the voltage across the capacitor C_{P}does not change immediately, the common voltage level V_{COM} drops ΔV2 correspondingly. Hence, negative charges stored in the parasitic capacitor C_{P} are recycled to the capacitor 328 through the second controlling circuit 330 conducted by the second controlling signal S2′; the capacitor 328 is charged by the parasitic capacitor C_{P}. Because the capacitor 328 has already stored part of the negative charges recycled from the parasitic capacitor C_{P}, next time when the common voltage source 310 provides the low common voltage level V_{COML}, the time required for the low common voltage driving circuit 324 to discharge the capacitor 328 to the low common voltage level V_{COML} is shortened and power consumption is reduced. In the above embodiments, ΔV1 and ΔV2 are voltage adjusting values for the source voltage level V_{SOURCE} to enable the charge recycling mechanism during charge recycling. The values of ΔV1 and ΔV2 are adjustable according to different system requirements.

When the charge recycling is complete and the common voltage level V_{COM} is switched from the low common voltage level V_{COML} to the high common voltage level V_{COMH}, the controlling circuit 350 controls the first controlling signal S1′ and the second controlling signal S2′ to open the first controlling circuit 326 and the second controlling circuit 330, respectively. The controlling circuit 350 also controls the second controlling signal S2 to conduct the second controlling circuit 322 in order to reuse the charges recycled into the capacitor 320. Then, controlling circuit 350 controls the first controlling signal S1 to conduct the first controlling circuit 318. The high common voltage driving circuit 316 keeps providing charge to the capacitor 320 to maintain the voltage across capacitor 320 at the high common voltage level V_{COMH} until the output voltage level of the common voltage source 310 reaches the high common voltage level V_{COMH}.

To further save power, the controlling unit 350 further outputs a third controlling signal S3 to the high common voltage driving circuit 316 to turn off at least some circuit elements (such as operational amplifiers) of the high common voltage driving circuit 316 when outputting the first controlling signal S1 to decouple the high common voltage driving circuit 316 from capacitor 320. In another example, the controlling unit 350 further outputs a third controlling signal S3′ to the low common voltage driving circuit 324 to turn off at least some of the circuit elements (such as operational amplifiers) of the low common voltage driving circuit 324 when outputting the first controlling signal S1′ to decouple the low common voltage driving circuit 324 from the capacitor 328.

Please note that the charge recycling system 300 mentioned above is only an embodiment of the present invention. The charge recycling mechanism disclosed can also be implemented only in the high common voltage source 312 or the low common voltage source 314 to recycle charges in a specific time period. This also achieves the advantages of higher charge utilization efficiency and lower power consumption. Moreover, the capacitors 320 and 328 can be replaced by any charge-storing unit, and these modifications belong to the scope of the present invention.

Those skilled in the art will readily observe that numerous modifications and alterations of the device and method may be made while retaining the teachings of the invention.

What is claimed is:

1. A charge recycling system, comprising:
a common voltage source, disposed in a liquid crystal display, the common voltage source comprising:
a first voltage source, for outputting a first common voltage level, comprising:
a charge-storing unit;
a voltage driving circuit, for outputting the first common voltage level;
a first controlling circuit, for selectively coupling an output end of the voltage driving circuit to the charge-storing unit according to a first controlling signal; and
a second controlling circuit, for selectively coupling the charge-storing unit to an output end of the common voltage source according to a second controlling signal;
a controlling unit, coupled to the common voltage source, for generating the first and second controlling signals and a charge recycling enabling signal, wherein the controlling unit outputs the charge recycling enabling signal when the first controlling circuit is not coupled to the voltage driving circuit and the charge-storing unit and the second controlling circuit is coupled to the charge-storing unit and the output end of the common voltage source; and
a source driving circuit, coupled to the controlling circuit, for adjusting a source voltage level when receiving the charge recycling enabling signal.

2. The charge recycling system of claim 1, wherein the common voltage source further comprises a second voltage source, for outputting a second common voltage level lower than the first common voltage level; before the common voltage source switches from the first common voltage level to the second common voltage level, the controlling unit outputs the charge recycling enabling signal to control the source driving circuit to boost the source voltage level.

3. The charge recycling system of claim 1, wherein the common voltage source further comprises a second voltage source, for outputting a second common voltage level higher than the first common voltage level; before the common voltage source switches from the first common voltage level to the second common voltage level, the controlling unit outputs the charge recycling enabling signal to control the source driving circuit to pull down the source voltage level.

4. The charge recycling system of claim 1, wherein the source driving circuit further adjusts the source voltage level according to an original source voltage level before adjusting.

5. The charge recycling system of claim 1, wherein when the controlling unit generates the first controlling signal to make the first controlling circuit not coupled to the voltage driving circuit and the charge-storing unit, the controlling unit further generates a third controlling signal to the voltage driving circuit to turn off at least one circuit element of the voltage driving circuit.

6. A common voltage source applied in a liquid crystal display, comprising:
a charge-storing unit;
a voltage driving circuit, for outputting a common voltage level;
a first controlling circuit, for selectively coupling an output end of the voltage driving circuit to the charge-storing unit according to a first controlling signal; and
a second controlling circuit, for selectively coupling the charge-storing unit to an output end of the common voltage source according to a second controlling signal.

7. A charge recycling method, comprising:
detecting clock signals of a common voltage source of a liquid crystal display; and
before the common voltage source switches a common voltage level, controlling a source driving circuit to adjust a source voltage level according to the common voltage level, and controlling the common voltage source to make a voltage driving circuit of the common voltage source not coupled to an output end of the common voltage source.

8. The charge recycling method of claim 7, wherein the step of controlling the source driving circuit to adjust the source voltage level comprises:
before the common voltage level is switched from a high common voltage level to a low common voltage level, controlling the source driving circuit to boost the source voltage level; and
before the common voltage level is switched from the low common voltage level to the high common voltage level, controlling the source driving circuit to pull down the source voltage level.

9. The charge recycling method of claim 8, wherein the step of controlling the source driving circuit to boost or pull down the source voltage level comprises adjusting the source voltage level according to an original source voltage level before adjusting.

10. The charge recycling method of claim 7, further comprising:
when the common voltage level is switched from the low common voltage level to the high common voltage level, controlling the common voltage source to couple a high common voltage regulating capacitor of the common voltage source to an output end of the common voltage source and then to couple a high common voltage driving circuit to the output end of the common voltage source; and
when the common voltage level is switched from the high common voltage level to the low common voltage level, controlling the common voltage source to couple a low common voltage regulating capacitor of the common voltage source to the output end of the common voltage source and then to couple a low common voltage driving circuit to the output end of the common voltage source.
